(19) United States
(12) Patent Application Publication
(10) Pub. No.: US 2015/0110277 A1
(43) Pub. Date: Apr. 23, 2015

(54) Wearable/Portable Device and Application Software for Alerting People When the Human Sound Reaches the Preset Threshold

(71) Applicants: Charles Pidgeon, Arlington, MA (US); Yuchien Wei, Plainsboro, NJ (US)

(72) Inventors: Charles Pidgeon, Arlington, MA (US); Yuchien Wei, Plainsboro, NJ (US)

(21) Appl. No.: 14/461,411

(22) Filed: Aug. 17, 2014

Related U.S. Application Data
(60) Provisional application No. 61/894,082, filed on Oct. 22, 2013.

(51) Int. Cl. H04R 29/00

(52) U.S. Cl. CPC H04R 29/008
USPC 381/56

(57) ABSTRACT

The present invention relates generally to a portable/wearable device as well as application or a software program to be downloaded onto a mobile device or computer. The present invention is intended to measure sound intensity/level and provide an alert signal to remind user(s) or crowds (i.e groups of people) that they are speaking too loud or making too much noise. Furthermore, optionally, the device may play a pre-selected music or pre-recorded message when the sound level threshold is exceeded, which can encourage all of the users to use the bio-feedback of the present invention to relax when they see the visual que such as the light color changes, hear the music, message or produced from the device. Another object of the present invention is to help people to know whether his/her voice is loud enough to be heard by people who have hearing impairment.

### REFERENCE TO RELATED APPLICATIONS

This patent application claims the benefit of U.S. Provisional Application No. 61/894,082 filed on Oct. 22, 2013, the disclosure of which is incorporated herein by reference in its entirety.

### BACKGROUND OF THE INVENTION

1. Field of the Invention

The present invention relates generally to a device, application and method for use in behavior management. More particularly, the present invention relates to a device, application and method for measuring the human sound intensity/level and alerting people when one of the users produces a sound intensity (typically from their voice) that exceeds or is below the sound threshold set by the user or preset by the manufacturer of the device.

2. Description of Related Art

Frequently, people make noise by unknowingly speaking loud in a crowd. For example, a group of students in a classroom or conference room normally make a significant amount of noise unknowingly. It is difficult for teachers to yell over a crowd of students to calm them down. Therefore, there is a need for an app and/or device to measure sound level and automatically give an alert signal to alert the students that they are too loud.

Frequently, people who speak loud will become emotional or they are already emotional and this is in part, the reason for people to speak loud. When people feel they have something to say and wish to be heard they tend to raise their voice often spontaneously and/or this may be a subconscious act of behavior. When people fight or have an argument, they tend to speak loud. A lot of fights end up with hurting words hurting each other and physical violence or emotional violence which is sometimes referred to as “breaking each other's heart”. Angry people tend to speak loud even in close or intimate relationships such as family members, couples and best friends. Angry people may not intend to hurt each other but when people are in an angry mood it is difficult to control their behavior. Therefore, there is a need to remind people of their loud voice or loud noises that they are creating. Moreover, there is a need for easing the mood when the conversation becomes angry, emotional and/or loud.

Conversely, for people who have hearing impairment or wearing a hearing aid, speaking above a certain sound level is needed in order to be heard by the person with a hearing disability; this may be necessary when people with normal hearing speak to people who have hearing impairments or are wearing hearing aids. Therefore, in this situation, there is a need to monitor the sound level and give alerts when the sound is below the sound threshold needed to be heard by the person who has difficulty hearing. This assumes that the majority of the sound under consideration results from the voice of the normal person without the need for a hearing device. Also, this may cause people to set the sound level of the telephone, radio or television for adequate hearing by the person with a hearing disability.

### SUMMARY OF THE INVENTION

Therefore, in light of the above, and for other reasons that will become apparent when the invention is fully described, an object of the present invention is to remind people of their loud or soft voice, which is an intended use of the present invention. The invention will not only indicate loud voices but also loud sounds/noises in their environment.

Another object of the present invention is to ease the mood when the conversation becomes heated and loud and the present invention is intended to provide a warning mechanism to indicate a heated and loud, potentially stressful situation.

Another object of the present invention is to help people who frequently need to talk to people who have hearing impairment.

Still another object of the present invention is to provide an app and/or software which are to be downloaded onto mobile devices and/or a computer so that people can use mobile devices or computers to monitor the sound level and use the mobile devices' and computers' sound unit to play an alarm, alerting tone, music and/or messages as well as using the mobile devices' display screen and graphics to display visual effects.

Yet another object of the present invention is to provide a light weight, small, compact and wearable device which can monitor the sound intensity/level and play an alarm, alerting tone, music and/or one or more messages when the sound intensity is higher or lower than the threshold level set by the user or the manufacturer. Because not everyone has a mobile device to use the aforementioned app of the present invention, it is anticipated that a device be manufactured that is dedicated to measuring the sound level, the sound input, output, threshold level, recording, play-back and display needed to practice the present invention.

The present invention relates generally to a light weight, small, compact portable/wearable device which comprises (i) a sound intensity/level meter which measures the sound intensity/level, (ii) a visual output unit; (iii) an audio output unit; (iv) an audio input unit, (v) a vibrating unit; (vi) a component (or user interface) for enabling a user to set the sound intensity threshold, at which the sound level meter sends signals to trigger the visual and/or audio and/or vibration output, and (vii) a component capable of triggering the audio and/or visual output when the sound level reaches the preset sound threshold. The device of the present invention is to alert people when one of the users produces a sound intensity (typically from their voice) that exceeds or is below the sound threshold set by the user or preset by the manufacturer of the device.

Sound intensity thresholds are set based on the purpose for using this device. If the user is concerned about anger management, stress or related emotions, then the threshold is intended to set a sound level whereby if it is exceeded, the device produces an alert signal. If the user is concerned with speaking a minimal sound intensity for someone with a hearing disability, then the threshold is a setting on the device to warn users they are not speaking loud enough for the other person with the hearing disability to hear the voice.

The present invention relates generally to an application (or “app”) or a software program to be downloaded onto a mobile device including but not limited to a smartphone, a tablet, a laptop computer. For simplicity, the application for mobile devices and the software for computers are sometimes grouped as “app” in general hereinafter in this patent application. For simplicity, the mobile devices and computers are sometimes grouped as “mobile device” in general hereinafter in this patent application. A smart phone includes but is not limited to an iPhone®, androids and the like. A tablet includes but is not limited to an iPad® and the like. The app comprises: (i) a sound level meter component which measures the sound level, (ii) an audio output component; (iii) an audio input component, (iv) a visual output component; (v) a component (or user interface) for enabling a user to set the sound intensity level threshold, at which the sound level meter sends signals to trigger the audio and/or visual output, and (vi) a component capable of triggering the audio and/or visual output when the sound level reaches a preset sound threshold. The app of the present invention is to alert people when one of the users produces a sound intensity (typically from their voice) that exceeds or is below the sound threshold set by the user.

The invention relates to a stand-alone light-weight, small, compact, portable/wearable device such that it can be comfortably wearable on a wrist, around neck, on clothing, such as a wrist band, pendant, ring, pin, or embedded in a watch or jewelry. The invention may be a desk or wall display. The device of the present invention is visible. The device is easy to use. The device has a means for measuring sound intensity/level, a pre-set sound intensity threshold range, a means to allow users to set sound intensity thresholds, and an alert signal produced in real time. Different alert colors can be used to indicate different levels of the sound; for example, a green light may indicate that the sound level is far from the preset sound threshold, a yellow light may indicate that the sound level intensity is close to a preset sound threshold level, and a red light may indicate the speaker has reached the preset sound threshold. Alerts may increase with the measured sound intensity level. For example color intensity (from the device) can be made proportional to the sound intensity (in the local environment), that means, the red color changes from low red intensity to a bright red intensity with increase of the environmental sound. Alternately, in a simplified embodiment, the light stays off when the preset sound threshold is not reached; only when the preset threshold is reached the light is turned on.

The display screen may be set to display the sound level reading and light/color alerts. No electrostatic discharge (EDS) or electromagnetic interference (EMI) from the device is anticipated. The device should maintain a retrievable history of the voices activating the device which is secure in the sense that there is no way it violates privacy of the user. A power supply (for example one or more batteries) should provide power to the device for at least 8 hours of operation including the on/off button to turn on and off the device. The device further comprises an on/off button to turn on/off the sound beeping alert. The device also comprises means for counting and recording how many times that the user's sound exceeds the threshold.

Typically, a sound intensity/level meter includes a microphone that samples the sound. It further includes electronic circuits that measure the sound detected by the microphone, amplify and filter it in various ways before showing a readout on a digital LCD display or triggering an alert signal.

In one embodiment, the device comprises a sound level meter component which measures the sound level; visual output unit; a component (or user interface) for enabling a user to set the sound intensity level, i.e., sound threshold, at which the sound level meter sends signals to trigger the visual output; and a component capable of triggering the visual output when the sound intensity reaches the sound intensity threshold. The visual output includes lighting color changes from green to red once the sound level exceeds the threshold. The intensity of the red light increases with the increase of the sound level from low red to bright red. The output unit may be an assembly of LED lights.

In a simplified embodiment, the light stays off when the preset sound threshold is not reached; only when the preset threshold is reached the light is turned on.

In another embodiment, the device may comprise an audio output unit so that when the sound level exceeds the threshold, the audio output is triggered to produce beeping sounds in addition to the visual effect or alone.

Optionally, the app and stand-alone portable/wearable device may be modified to contain a recording component which can play back the sound (or conversation) when the conversation voices exceeded the sound threshold set by the users.

Optionally, the app and stand-alone portable/wearable device may be modified to contain digital files that are the user's favorite songs or messages to calm down the user when the sound level exceeds the sound intensity threshold.

In another embodiment, the device may comprise a vibrating unit that produces vibration to alert the user when the sound level exceeds the sound threshold.

Alternatively the portable/wearable device of the present invention can be set up and interfaced with a smart phone (e.g. iPod® and androids) or different tablets (e.g. Pad®).

The sound level meter of the present invention is primarily intended for measuring the intensity of the sound level of human voices during a conversation or in a classroom or conference, between two or more people. The sound level not from voices is also monitored if desired. The audio input component of the present invention also allows a user to use it to receive the sound to monitor. The audio input component of the present invention also allows a user to download or record alerting tones, music, and/or messages and save them in the audio files in mobile devices which the app of the present invention resides and/or device of the present invention so that the app and device can access and play through audio output component later. One use or purpose of the present invention is to alert one or more of the users when they are talking too loud, which may be an indication of stress, conflict and/or disagreement among the users. The app of the present invention uses the mobile devices' microphone as a part of the audio input component/sound level meter to receive the sound to monitor or record the sound, statement (message) or music generated by the user and to be played back later. The app of the present invention uses mobile devices' speaker to play alerting tones, music, and/or messages. The stand-alone device has its own microphone and speaker.

Talking loud can occur when individuals are arguing, fighting or having a conflict. The present invention is focused on alerting people when they are fighting or having a conflict.

Briefly, the audio/visual output is a warning system that is in effect a biofeedback mechanism for the users to recognize when they may be in a conflict. If users agree to alter their behavior from a high-energy interaction to a more calm interaction when they receive bio-feedback from the present invention, then the present invention functions as a mechanism to slow down or perhaps stop people from arguing during a stressful interaction. If and when this occurs the emotional level of the users should be reduced when they continue to converse.

An anticipated modification of the present invention is that the present invention may be used to record the conversation among individuals so that the users of the present invention may listen to what they were saying when their voice levels exceeded the threshold set by the user(s). Another anticipated application of the present invention is to warn the users that the persons receiving their speech, is having trouble hearing and understanding the voice of the presenter of the information.

The invention also relates to an app (including application and software) to be downloaded to a mobile device (including mobile device and computer). The app comprises (i) a sound level meter component which measures the sound level, (ii) an audio output component; (iii) an audio input component, (iv) an visual output component; (v) a component (or user interface) for enabling a user to set the sound level threshold, at which the sound level meter sends signals to trigger the audio and/or visual output, and (vi) a component capable of triggering the audio and/or visual output when the sound level reaches or exceeds the sound threshold.

Once triggered by the sound level meter, the app on the mobile device and/or the stand-alone device can (i) play a pre-recorded sound effect including beeping, alarming, alerting tones, (ii) music and/or (iii) a pre-recorded message. Thus, the device may contain a microphone to record a sound, statement or music generated by the user.

The present invention is intended to provide an alert signal to remind user(s) or crowds that they are speaking too loud or making too much noise. Furthermore, optionally, the device may play a pre-selected music or pre-recorded message so that the parties engaging in the conversation who are making noise, which can encourage all of the users to use the bio-feedback of the present invention to relax when they hear the music, message or visual que produced from the device when the sound level threshold is exceeded.

Regarding anger management, the optimum location for using the present invention is in rooms, cars or other places where there is a limited amount of a noisy background. A noisy background may cause the present invention device to send out the alert signal when there is no stress or anger among the users.

In an exemplary embodiment of the present invention, there is disclosed a stand-alone portable/wearable device. The device comprises (i) a sound level meter which measures the sound level, (ii) an audio output unit; (iii) an audio input unit, (iv) an visual output unit; (v) vibrating unit; (vi) a means (or user interface) for enabling a user to set the sound level threshold, at which the sound level meter sends signals to trigger the audio and/or visual output, and (vii) a means capable of triggering the audio and/or visual output when the sound level reaches sound threshold.

The audio output unit and input unit combined are also referred as the sound module in this document.

Another anticipated function of the present invention is to allow the users to record their conversation so that they can replay it or listen to what they were saying during the stressful conflict which caused their voices to increase in intensity.

The device may have a central processing unit(s) (CPU) as a control means for allowing a user to set a sound level threshold and therefore control the operation of the device with regard to when the alert signal and/or music, messages is produced.

The device may have a display screen showing measured sound level readings. The display screen may be a backlit display and/or other suitable display. The device may have a lighting device, which may be an LED.

The sound level meter is capable of monitoring the sound level of human voices during a conversation. Alternatively, the sound level meter component of the present invention can be used to monitor the sound in a classroom of students or conference room with a group of participants. The sound level meter measures the sound level (volume) and the measured reading may be displayed on the screen of the present invention or projector on a computer screen. If the sound level exceeds a pre-determined threshold, the sound level meter sends signals to the CPU and the CPU sends signals to the sound module (i.e. audio output and input units) or lighting device (i.e. visual output unit). Once receiving the signal from the CPU, the lighting device starts to flash and/or the sound module starts to beep or send off alerting tones. This warning can remind people that his or her volume has exceeded the preset threshold. Optionally, the sound module once triggered by the signal from the CPU, the sound module can play music or pre-recorded messages.

The detailed construction and operation of the sound level meter is a known technology and is therefore not described herein. It is contemplated that any suitable technology used in commercially available sound level meter or loudness meter could be employed in the device of the present invention.

The sound module includes an audio input unit and audio output unit. The sound module may include a memory for digitally storing a plurality of pre-recorded sounds and a central processing unit for controlling operation of the sound module, a speaker for outputting audible sounds. The device may contain at least one USB or mini USB port for downloading, to the sound module, music or pre-recorded messages from a computer or mobile device or a means for wireless receiving music from the internet. Alternatively, a user can pre-record messages using a computer or a mobile device, tape recorder or some other method and then transfer the pre-recorded message to the present invention device using a USB or mini-USB port on the device.

Alternatively, the device (or sound module) may comprise a microphone and a hold-down button for the user to pre-record messages which are stored in the memory of the sound module.

The invention may have various forms and shapes. For example, the device may be packaged as or included in a wrist band, bracelet, watch, necklace, and pen, etc.

The invention may have a large display board to display the sound level reading and equipped with a large speaker so it can be put in a classroom or a conference room to show the crowd their noise level and send off an alert signal or music or pre-recorded message once the sound intensity/level exceeds a pre-determined level.

In an exemplary embodiment of the present invention, there is disclosed an app for a mobile device including but not limited to a smartphone (such as iPhone® and androids, etc.) and tablet (such as iPad®, etc.) and a software for the computer. The app and/or software comprises (i) a sound level meter component which measures the sound level, (ii) an audio and/or visual output component, (iii) an audio input component, (iii) a component (or user interface) for enabling a user to set the sound level threshold, at which the sound level meter sends signals a trigger to the audio and/or visual output, and (v) a component capable of triggering the audio and/or visual output when the sound level reaches the sound threshold set by the user or manufacturer.

The sound level meter module is known in the art. The sound module (component) is also known in the art. Some of these modules are referred to as a music player app.

The app of the present invention is to combine both components or technologies in one app and have a controlling means and communication means between the two components, for example, a mechanical or software switch that toggles between the two components.

The app may simply act as a controlling means and communication means to use the existing sound level meter app and music player app which already exists in the market.

The sound level meter component can use a mobile device's microphone to receive the sound of the human conversation.

The app of the present invention may also use the mobile device's screen to display sound level readings. The app may also use the mobile device's alarm to send off alarm warning sounds or use the mobile device's LED to flash when the sound level exceeds or is below the threshold.

When the sound level exceeds the threshold, the music player component may use the mobile device's speaker to play music or message to ease the conversation.

The most important features of the present invention have (1) thus been outlined in order that the more detailed description that follows may be better understood, and (2) demonstrate the present contribution to the art that is provided by the present invention. This may allow a better appreciation of the present invention. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the design of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view of a device which is light weight, small, compact and wearable according to the principle of the present invention.

FIG. 2 is an isometric view of a device on a desktop or hung on a wall according to the principle of the present invention.

FIG. 3 is a schematic view of the device without manual operation buttons.

FIG. 4 is a schematic view of the device in the device with manual operation buttons which has separate processing center for separate units.

FIG. 5 is a schematic view of the device in the device with manual operation buttons which has one CPU for the device.

FIG. 6 is a block diagram of the app according to the principle of the present invention.

### DESCRIPTION OF THE PREFERRED EMBODIMENT

This invention relates generally to a device and/or application (“app” hereinafter) on an electronic mobile device comprising a sound level meter and a sound module. More particularly, the invention relates to a device and/or application on an electronic mobile device comprising a sound level meter for measuring sound level of human voice/conversation and a sound player which once triggered by the sound level meter will play music or a pre-recorded message The device monitors and measures the sound level (volume or intensity) of human voice(s) during a conversation, once the sound level exceeds the pre-determined threshold; the device gives off an alert signal to remind user(s) or crowds that they are speaking too loud or making too much noise. Furthermore, optionally, the device may play a pre-selected music or pre-recorded message so that the parties engaging the conversation or making noise can relax by the music or message.

### (I) Light Weight, Small, Compact Portable/Wearable Device

In one embodiment, the device comprises a microphone, electronic circuits connected to the microphone, and an LED assembly connected to the electronic circuits. The microphone is used for sampling an input sound. The electronic circuits including at least one amplifier and filter are designed to measure the input sound detected by the microphone and amplify and filter the sound. The electronic circuits have at least one position that defines the preset sound intensity/level threshold, for example, the thresholds are set at 30 db, 50 db, and 75 db. The LED assembly is used to produce at least one light color when the input sound intensity/level reaches the preset sound intensity threshold.

In another embodiment, the device comprises a user interface, application algorithms, hardware access module, and hardware. The algorithms are responsible for running the device. The algorithms should include anger determination procedures for each level of anger depending on sound measurement data and alerting procedures for each level of sound intensity.

The change of sound intensity level is monitored with a programmable digital meter that would be built with a sound intensity meter, clock, memory storage and microprocessor.

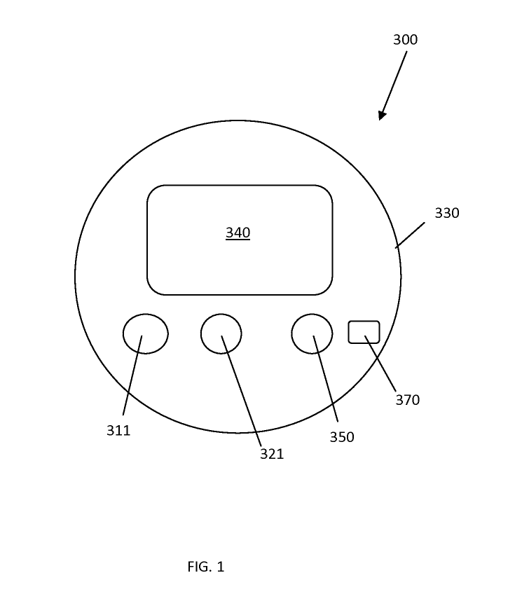

Referring to FIGS. 1-5, the present invention relates to a portable/wearable device 300 which comprises a sound level meter 310, a sound model 320, and a visual output unit 355; all of them are enclosed in a housing 330. The device 300 may have one or more microphones 311 for the sound level meter 310 to receive the sound for measurement and/or for the sound module 320 to receive messages/music to record. The microphone 311 can be considered a part of the audio input unit. The sound module 320 has a speaker 321 which is a part of an audio output unit. It may also comprise a display screen 340 which is considered a part of the visual output unit. It may further comprise a lighting component 350 which is also considered a part of the visual output unit. The sound level meter 310 and sound module 320 are connected through an electronic connection such as wire. The device further comprises a data storage center 386 where the system saves the occurrences of sending an alert signal in history so that the user can track and improve. The data collected can be downloaded to a flash drive using the USB port 326.

The sound module 320 is also referred to as a combination of an audio output and audio input. The audio output includes a speaker and audio input includes a microphone.

The device 300 further comprises a vibrating alert unit 370 for producing a vibrating alert. The vibrating alert is produced by a small electric motor connected to an eccentric weight.

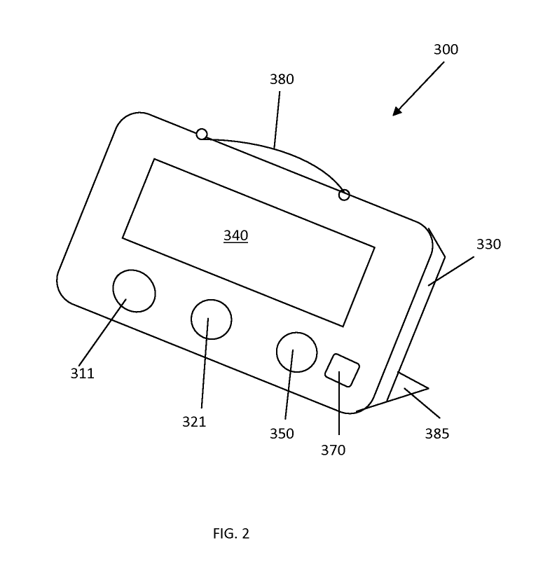

The device 300 further comprises a power supply 360 (not shown in FIG. 2) connected to both the sound level meter 310 and the sound module 320 for providing electrical power to the device 300 including the sound level meter 310, visual output unit 355, vibrating alert unit 370, and sound module 320. The Power supply 360 may vary and can include disposable, long life or chargeable batteries. The device 300 further comprises a recharger 361 to charge the battery 360 from an external power supply.

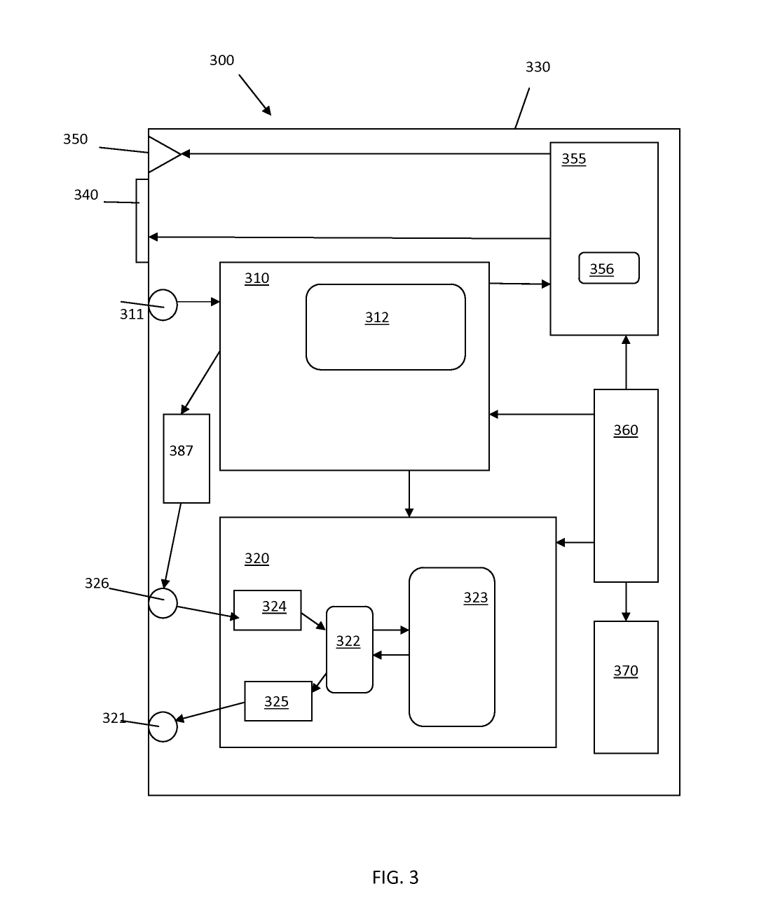

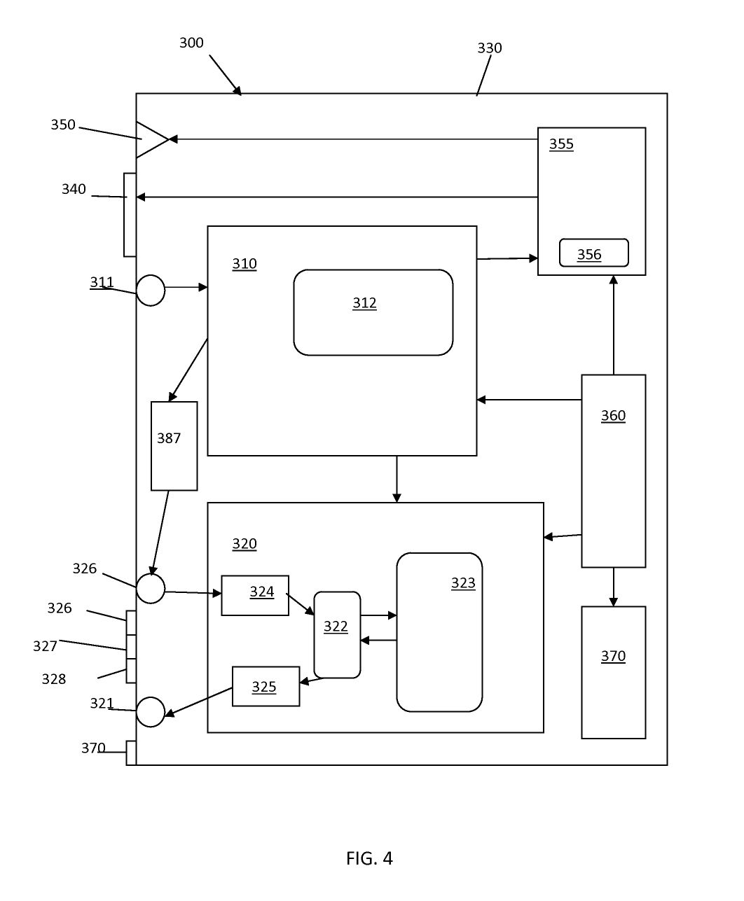

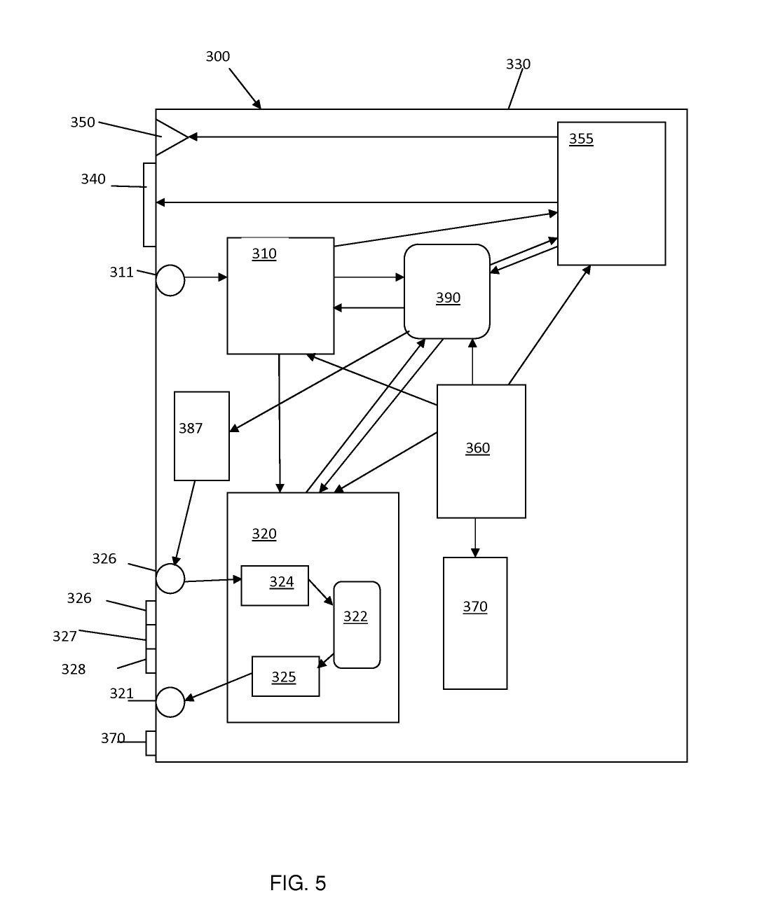

The sound level meter 310, sound module 320, and visual output unit 355 may have separate CPUs or microprocessor (as shown in FIGS. 3 and 4) or they can share one CPU (central processing unit) or microprocessor (as shown in FIG. 5). The CPU with application algorithms controls the operation of the device. The device may also have a button 370 to turn on and off the device. The device may also contain an auto-off mechanism (not shown in FIG. 2). The device also contains an on/off button to turn on/off the sound alert in case the user is in a quiet environment. Other buttons for manual operation to record or play the music/message are optional and will be discussed later. The device may vary in size. The small sized wearable device may be worn on wrist, around neck, attached to clothing including but is not limited to a wristband, pendant, pin, or pen. The device may be embedded or packaged or included in other forms, such as in a watch, or a piece of jewelry. The large sized device may be hung on a wall with a hanger 380 or stand on a desk with a support 385 (FIG. 2). The display screen 340 is also optional. The display screen 340 may be a backlit display screen.

### A. Sound Level Meter 310

The detailed construction and operation of the sound level meter 310 is known technology and is therefore not described herein. It is contemplated that any suitable commercially available sound level meter or loudness meter could possibly be employed in the device/application of the present invention. The sound level meter 310 may have its own processing unit or CPU 312.

### B. Sound Module 320

The detailed construction and operation of the sound level meter 310 is known technology and is therefore not described herein. It is contemplated that any suitable commercially available sound level meter or loudness meter could possibly be employed in the device/application of the present invention.

Before explaining at least one embodiment of the invention in detail, it is to be understood that the invention is not limited in its application to the details of construction and the arrangements of the components set forth in the following description or illustrated in the drawings.

Referring to FIG. 3, there is disclosed a schematic view of the device generally designated as 300. The device 300 comprises a sound meter 310, a sound module 320 for producing sound which may comprise, a memory 322 for storing pre-recorded audio files, a microprocessor or central processing unit (CPU) 323 for controlling operation of the sound module 320 and either an analog-to-digital converter (ADC) 324 or a digital-to-analog converter (DAC) 325 or both. The microprocessor or CPU is considered a means for enabling the user to set threshold and control the operation of the device 300. The sound module 320 further comprises a speaker 321 for outputting sounds. The sound module 320 is connected to the sound level meter 310 and power supply 360 through electronic connection. The device 300 also comprises a visual unit 355 for producing visual effect on the display screen 340. The visual unit may have its own CPU 356.

The sound module 320 may be a universal serial bus (USB) direct sound module which allows a user to program their own music and create sound that they need. The device further comprises a USB connector 326 and an interface. The user can re-program the sound module by connecting the sound module 320 to a computer or a mobile device (e.g. smart phone, tablet) and download the sound file from websites or apps and save these files in the CPU 323. The user can even record his/her own message using a computer or digital recorder and download the audio file saved in the computer or digital recorder to the sound module 320 via the USB port 326.

When the measured sound level exceeds the pre-set threshold, the sound level meter 310 sends signal to the CPU 323 of the sound module 320 to actuate the sound module to beep or send off alerting tone or play pre-selected music or message.

The CPU 323 also has a means to allow users to create a play list of music and message. The CPU 323 also has means to allow user to choose what type of the alert signal to send off when triggered by the signal sent from the sound level meter 310. The CPU 323 allows the user to choose that the sound module produces beeping sound, alerting tone, playing music of choice, or playing recorded messages.

Optionally, the sound module 320 may include user interface so that a user can manually operate the sound module 320. The user interface includes push to play buttons 326 that are located on the device disclosed in FIG. 4 so that a user can selectively play the sounds. The play buttons 326 may also be configured on a touch screen if the device has a touch screen. The user interface may also include record buttons 327 or stop button(s) 328 that are located on the device like other typical audio recorder provides. The record and play buttons are connected to the CPU 323. By pushing the record buttons a user can record music or message like other typical recorder provides, the music/message will be delivered through the microphone and converted from analog to digital and saved as an audio file in the CPU. The audio file may be stored in any of a variety of digital audio formats known to those skilled in the art. When pushing the play button, the CPU will retrieve the audio file and convert it from digital to analog and broadcast through the speaker.

### C. Visual Output Unit 355

Visual Output Unit 355 produces visual effect. The visual effect includes lighting of an LED. The visual output includes lighting color changes from green to red once the sound level reaches the threshold (either beyond or below the threshold). The intensity of the red light increases with the increase of the sound level from low red to bright red. The output unit may be an assembly of LED lights.

In a simplified embodiment, the light stays off when the preset sound threshold is not reached; only when the preset threshold is reached the light is turned on.

### D. Vibrating Alert Unit 370

The vibrating alert unit 370 produces vibrating alert. The vibrating alert is produced by a small electric motor connected to an eccentric weight.

The sound level meter 310, sound module 320, vibrating alert unit 370 and visual output unit 355 may have separate CPUs 312, 323 and 356 (as shown in FIGS. 3 and 4) or they can share one CPU 390 (as shown in FIG. 5).

The device may further comprise a temperature sensor to monitor the temperature in addition to the sound intensity/level so that the user can compare whether his or her biological signs correlates to the loudness of his or her voice.

The method of or arrangement of wiring or connecting the above electronic components and mounting them will be well known to those with ordinary skill in the electronic and mechanical arts.

A method for using the device according to the principle of the present invention comprises the following step:
1. The user pushes the button to turn on the device.
2. The system displays Mode Selection Menu which includes but is not limited to the training mode, threshold setting mode, and user normal use mode. The device allows the user to choose the purpose of use of the device which is either anger/stress management or communicating with people who have hearing impairment. For anger/stress management, once the sound intensity/level reaches the threshold, the device continues to send alert signals until the user's sound intensity/level is below the threshold. For the purpose of communicating with people who have hearing impairment, once the sound intensity/level reaches the threshold, the device continues to send alert signals until the user's sound is beyond the threshold. The purpose of use determines how the device monitors the sound.
3. If a threshold has not been set or saved, by default, the device displays a “setup” screen or a training mode to allow the user to set up a threshold.
4. If the user chooses not to set the user's threshold, the device uses the default threshold that is previously set by the manufacturer.
5. If the user decides to set his or her threshold, the system displays the recommended threshold range. There can be several sets of threshold ranges, each of which corresponds to a range of different sound intensity/level. Optionally, the device allows a user to calibrate his/her sound intensity/level and find the optimal threshold for him/her. One of ways to calibrate the user's sound level is that the device broadcasts sound of different levels so that the user can choose the threshold based on what he heard.
6. The user chooses one of the ranges and sets his or her sound intensity level threshold.
7. If the sound intensity/level threshold is within the device's recommended ranges, the device accepts and saves the threshold. If the threshold is outside the device recommended ranges, the device tells the user that the input threshold is outside the range. If the user insists the threshold, the device accepts and saves the threshold. Or the user changes the threshold input within the range and the device accepts and saves the threshold.
8. Once the device saves the threshold, the device displays in the normal use mode.
9. The device starts to monitor/measure the sound intensity/level
10. Once the device detects the sound intensity/level has reached the threshold, the device sends the alert signal in real time including vibration, lighting/color changes, beeping sound alert, and/or sending messages to alert the user, and/or playing music to calm down the user.
11. The device stops the alert signal if the user lowers down the sound level if the device is used for anger or stress management. Alternatively, the device stops the alert signal if the user increases the sound intensity/level if the device is used to help the user to know whether his/her voice is loud enough to be heard by people who have hearing impairment.
12. The device saves the occurrences of sending the alert signal in history so that the user can track and improve.

The present invention also relates to a method of monitoring the sound intensity/level and sending an alert signal in real time to remind users when the sound intensity/level reaches a sound intensity/level threshold that is preset by a user wearing the device or a manufacturer of the device. The method comprises the steps of providing a light weight small compact wearable/portable housing, providing and packaging means for monitoring and measuring the sound intensity/level in the housing, providing and packaging means for producing a visual alert signal in the housing, wherein the means for producing the visual alert signal is connected to the means for monitoring and measuring the sound intensity/level, and sends the visual alert signal to remind the user when the sound intensity/level reaches the preset threshold.

The method may further comprise the steps of providing and packaging means for sending an audio alert signal or means for sending vibrating alert signal or means for sending both audio and vibrating alert signals in the housing, wherein the means for producing the audio alert signal or vibrating alert signal are connected to the means for monitoring and measuring the sound intensity/level, and send the audio or/and vibrating alert signal to remind the user when the sound intensity/level reaches the preset threshold.

The method may further comprise the step of providing an USB port on the housing and means for transferring or downloading music or digital files of prerecorded messages using the USB port.

### (II) Application (or “App”) for Mobile Devices or Software for Laptop Computers

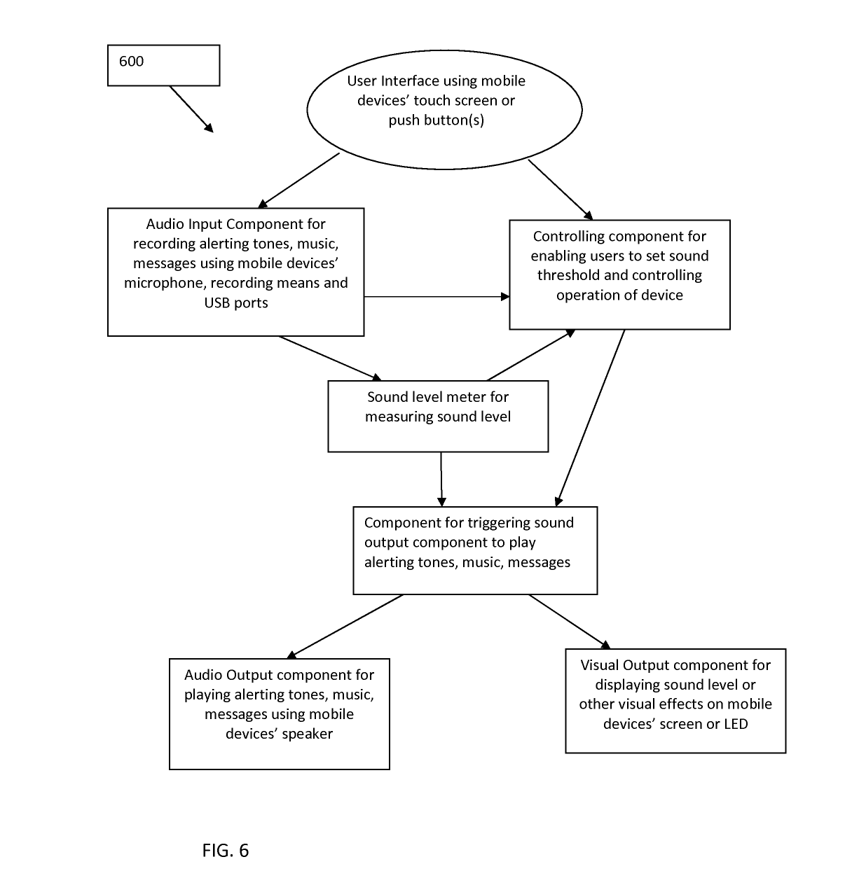

Referring to FIG. 6, there is disclosed a sound level alert and music playing app on a mobile device.

The app 600 comprises a sound level meter component which measures the sound level, an audio output component; an audio input component; an visual output component; a controlling component a user interface for enabling a user to set the sound intensity level, i.e., sound threshold, at which the sound level meter sends signals to trigger the audio and/or visual output, a controlling means for controlling operations of the device; and a component capable of triggering the audio and/or visual output when the sound level reaches sound threshold. The app of the present invention is to alert people when one of the users produces a sound intensity (typically from their voice) that exceeds the sound threshold set by the user and optionally plays pre-recorded and pre-selected music and/or messages to ease conversation.

The app may use a mobile device's microphone to measure noise volume in decibels (db) and also display the noise volume reading on the mobile phone's screen.

The app uses the mobile device's speaker to play the pre-recorded and/or pre-selected music and/or messages.

When the measured sound level exceeds the pre-set sound level threshold the sound level meter component sends a signal to trigger (turn on) the sound output to play pre-selected music or pre-recorded message.

The app further comprises a recording means (sound input component) for recording user's music and/or messages. The app may use a phone microphone and recording means to record the user's message and save the message in an audible file such that the sound output component can retrieve the file and play when triggered by the sound level meter component.

The app 600 displays the measured sound level and flashes using visual output when the measured sound level exceeds the sound level threshold. The app uses a phone's backlit screen to display the sound level readings and the phone's LED to flash. The app is able to turn on the phone's screen that's originally turned off.

The app may also use mobile the device's alarm to set off alarming sounds when the measured sound level exceeds the preset threshold.

Optionally, the app may use a music app on the mobile device to play music.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A visibly light weight small compact portable/wearable device that monitors sound intensities/levels, whereby the device sends an alert signal in real time when the sound reaches a sound intensity/level threshold that is preset by a user wearing the device or a manufacturer of the device, the device comprising:
a sound intensity/level measuring unit for monitoring the sound intensity/level; and
a visual output unit for producing at least one light color when the sound intensity/level impinging on the device reaches the preset sound intensity/level threshold.

2. The device of claim 1, wherein the sound intensity/level measuring unit includes a microphone for sampling an input sound and electronic circuits for measuring the input sound detected by the microphone and amplifying and filtering the sound; and the visual output unit includes an LED assembly for producing at least one light color when the input sound intensity/level reaches the preset sound intensity threshold; wherein the electronic circuits have at least one position that defines the preset sound intensity/level threshold; and wherein the electronic circuits are connected to the microphone and the LED assembly is connected to the electronic circuits; and wherein the visual output unit produces different light colors and changes colors corresponding to the at least one preset sound intensity/level threshold.

3. The device of claim 1, wherein the device is wearable on a wrist, around a neck, on clothing, or embedded in a watch or jewelry or pen, including one of a wristwatch, a pendant, and which is attached to the user's clothing.

4. The device of claim 3, further comprising a vibrating unit for producing a vibrating alert signal indicating that the sound intensity/level impinging on the device has reached the preset sound intensity/level threshold.

5. The device of claim 4, further comprising a sound output unit for producing a sound alert signal including a beeping sound, a ring tone, a pre-recorded vocal message, a music play indicating that the sound intensity/level impinging on the device has reached the preset sound intensity/level threshold.

6. The device of claim 1, wherein the alert signal increases with the sound intensity measured once the preset threshold is reached and exceeded and stops if the user lowers down the sound level.

7. The device of claim 6, wherein the device saves the occurrences of sending the alert signal in history so that the user can track and improve.

8. A light weight, small, compact and portable/wearable device for measuring sound intensities/levels and sending off an alert signal when the sound intensity/level reaches a threshold that is preset by a user wearing the device or a manufacturer of the device, the device comprising:
a processing unit;
a sound intensity/level unit for measuring sound intensity/level;
a visual output unit for producing a visual alert signal; and
a user interface for the user to set a threshold; and
wherein the visual out unit produces a visual alert signal in real time when the measured sound intensity/level reaches the preset threshold.

9. The device of claim 8, further comprising one of an audio output unit, a vibration unit, and the combination of both for producing the alert signal including one of lighting/color alert, sound alert, vibration alert, vocal message, music play, and the combination thereof in real time when the measured sound intensity/level reaches the present threshold.

10. The device of claim 9, wherein the alert signal increases with the sound intensity/level measured.

11. The device of claim 9, wherein the alert signal continues when the measured sound intensity/level stays beyond the preset threshold for an anger or stress management purpose.

12. The device of claim 9, wherein the alert signal continues when the measured sound intensity/level stays below the preset threshold to help the user to know whether his/her voice is loud enough to be heard by people who have hearing impairment.

13. The device of claim 9, further comprising at least one standard and/or mini USB port and means to transfer or download music or digital files of prerecorded messages to the device using the USB port or transfer data such as history of use using the USB port.

14. The device of claim 9, further comprising a recording means capable of recording and playing back the input sound.

15. The device of claim 9, wherein the device has different forms/shapes and is wearable on a wrist, around neck, attached to clothing, or is embedded in a watch or jewelry or pen.

16. The device of claim 9 further comprising a display screen for displaying the measured sound intensity/level reading or other images.

17. The device of claim 9 further comprising components for counting and memorizing how many times that the user's sound exceeds the threshold and data storage to save user's information and use history.

18. The device of claim 9, wherein the user interface enables the user to access one or more of the modes including training mode, calibration mode, thresholds setting mode, and normal operation mode wherein the user can choose whether to use the device to help manage anger/stress or help to communicate with people who have hearing impairment or choose whether set up his/her own threshold or using the device default threshold.

19. The device of claim 9, wherein the device has application algorithms which are responsible for running the device and which include determination procedures for whether the sound reaches thresholds and procedures for sending alert signals.

20. The device of claim 9, further comprising a temperature sensor to monitor temperature in addition to sound intensity/level.
